(19) United States
(12) Patent Application Publication
(10) Pub. No.: US 2014/0207478 A1
(43) Pub. Date: Jul. 24, 2014

(54) PHYSICIAN COMPOSITE QUALITY SCORING AND RATING METHODOLOGY

(71) Applicant: Comparion Medical Analytics, Inc., Greenville, SC (US)

(72) Inventor: M. Thane Forthman, Simpsonville, SC (US)

(73) Assignee: Comparion Medical Analytics, Inc., Greenville, SC (US)

(21) Appl. No.: 14/159,171

(22) Filed: Jan. 20, 2014

Related U.S. Application Data
(60) Provisional application No. 61/755,734, filed on Jan. 23, 2013.
(60) Provisional application No. 61/755,725, filed on Jan. 23, 2013.

(51) Int. Cl. G06Q 50/00; G06Q 10/06

(52) U.S. Cl. CPC G06Q 50/00; G06Q 10/06393
USPC 705/2

(57) ABSTRACT

Methodology for user-friendly scoring and rating relative composite quality performance of physician inpatient care uses various statistical methods. Physicians are respectively assigned multiple z-values to identify relative statistical significance associated with a plurality of quality indicators for various clinical categories using available databases. Once so assigned, each z-value is converted to a z-score to rescale to a standard normal distribution. Such z-scores are converted to a percentile value which serves as the physician's relative quality score for each quality indicator. Percentiles are then averaged across quality indicators to produce a raw composite percentile score, which is then resealed to a standard normal distribution using a z-score transformation for appropriate statistical distribution and equal weighting. Such z-score is then converted to a final percentile value which serves as the physician's terminal composite quality score, and which is assigned to a percentile-based reference range to determine a physician's composite quality rating.

### PRIORITY CLAIM

This application claims the benefit of previously filed U.S. Provisional patent application entitled “PHYSICIAN COMPOSITE QUALITY SCORING AND RATING METHODOLOGY,” assigned U.S. Ser. No. 61/755,734, filed Jan. 23, 2013, and which is incorporated herein by reference for all purposes, and claims the benefit of previously flied U.S. Provisional patent application entitled “HOSPITAL COMPOSITE QUALITY SCORING AND RATING METHODOLOGY,” assigned. U.S. Ser. No. 61/755,725, filed Jan. 23, 2013, and which is also incorporated herein by reference for all purposes.

### FIELD OF THE SUBJECT MATTER

The present subject matter relates generally to quality performance evaluation, and more particularly to scoring and rating relative composite quality performance of physician inpatient care.

### BACKGROUND OF THE SUBJECT MATTER

In general, it is challenging for healthcare providers, purchasers, and consumers to assess and compare the “overall” quality of physician inpatient care. See, “Risk-Adjusted Indices for Measuring the Quality of Inpatient Care” by Dr. Thane Forthman et al., Quality Management in Health Care. 2010. For example, when considering multiple quality indicators for the evaluation of care, a particular physician's mortality index might be “low”, while their complications and readmissions indices might be “high”, while their patient safety index is “average.” Such multiplicity of various factors makes it difficult to objectively determine a given physician's overall quality of care since no single, “composite” measure exists.

Additionally, making comparisons among physicians becomes even more complex given the vast number of potential performance combinations across quality indicators.

Consequently, a methodology for scoring and rating the relative composite quality performance of physician inpatient care is desirable.

While various aspects and alternative embodiments may be known in the field of making performance quality assessments, no one methodology has emerged that generally encompasses the above-referenced characteristics and other desirable features associated with performance quality assessment technology as herein presented.

### SUMMARY OF THE SUBJECT MATTER

In view of the recognized features encountered in the prior art and addressed by the present subject matter, improved methodology for healthcare providers, purchasers, and consumers to assess and compare the “overall” quality of physician inpatient care is provided.

The present subject matter relates, for example, to methodology using various statistical methods.

In one present exemplary methodology, each of a plurality of physicians may be assigned multiple z-values to identify the relative statistical significance associated with a selected number of quality indicators associated with various clinical categories. In one present exemplary embodiment, five (5) such quality indicators may be associated with up to 37 clinical categories. Such initial data may be obtained from any available source, such as using a company's state and national inpatient quality indicator databases.

In furthering such methodology, once z-values are assigned to each quality indicator by clinical category, each z-value may be converted to a z-score to rescale values for each quality indicator to a standard normal distribution. Such z-scores may then be converted per presently disclosed subject matter to a percentile value ranging from 0.01 to 99.9 which serve as the physician's relative quality score for each quality indicator. Further, per presently disclosed subject matter, such percentiles may then be averaged across quality indicators to produce a “raw” composite percentile score.

Per presently disclosed subject matter, such “raw” composite percentile score may then be resealed to a standard normal distribution using a z-score transformation to ensure an appropriate statistical distribution and equal weighting. Such z-score associated with the “raw” composite percentile score may then be converted to a final percentile value which serves as the physician's “terminal” Composite Quality Score (either state or national).

Still further, per some presently disclosed exemplary embodiments, such a physician's Composite Quality Score may then be assigned to one (1) of five (5) percentile-based reference ranges to determine the physician's Composite Quality Rating using a checkmark-based rating system; where for example the symbology “✓++” equals the “HIGHEST” quality rating and a “✓−−” equals the “LOWEST” quality rating. Such methodology provides a statistically reliable, user-friendly approach for providers, purchasers, and consumers to evaluate and compare the “overall” quality of physician inpatient care by clinical category.

Yet further, it is to be understood that the present subject matter equally encompasses corresponding devices and apparatus for practicing the present exemplary methodologies, and/or for operating in accordance with such exemplary methodologies. Likewise, it will be understood that the present subject matter may be variously implemented, including in different combinations of hardwired devices and/or computer-implemented devices utilizing software implementations. Those of ordinary skill in the art will better appreciate the features and aspects of such embodiments, and others, upon review of the remainder of the specification.

Additional objects and advantages of the present subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments and uses of the subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the present subject matter, not necessarily expressed in the summarized section, may include and incorporate various combinations of aspects of features, components, or steps referenced in the summarized objects above, and/or other features, components, or steps as otherwise discussed in this application.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 is an exemplary embodiment of a primarily numerical table template usable such as in a web-based software application in accordance with a presently preferred exemplary embodiment of the presently disclosed subject matter; and

FIG. 2 is an exemplary embodiment of a primarily checkmark-based rating table template such as in a web based software application in accordance with a presently preferred exemplary embodiment of the presently disclosed subject matter.

Repeat use of reference characters or their description throughout the present specification and appended drawings is intended to represent same or analogous features, elements, or steps of the presently disclosed subject matter.

### DETAILED DESCRIPTION OF THE PREFERRED EMBODIMENTS

As discussed in the Summary of the Subject Matter section, the presently disclosed subject matter is particularly concerned with methodology for providing physician composite quality scoring and ratings.

In some presently disclosed exemplary embodiments, both state and national composite quality scores may be provided, along with attendant composite quality ratings by physician. In some examples, such ratings may encompass five (5) quality measurement indices for 37 clinical categories.

Practice of the presently disclosed subject matter provides decision-makers (namely, healthcare providers, purchasers, and consumers) with the ability to easily and reliably evaluate and compare the “overall” quality of inpatient care provided by a particular physician. Without practice of the presently disclosed methodology, such decision-makers are unable otherwise to assimilate the various components of medical quality into a single, coherent measure of performance.

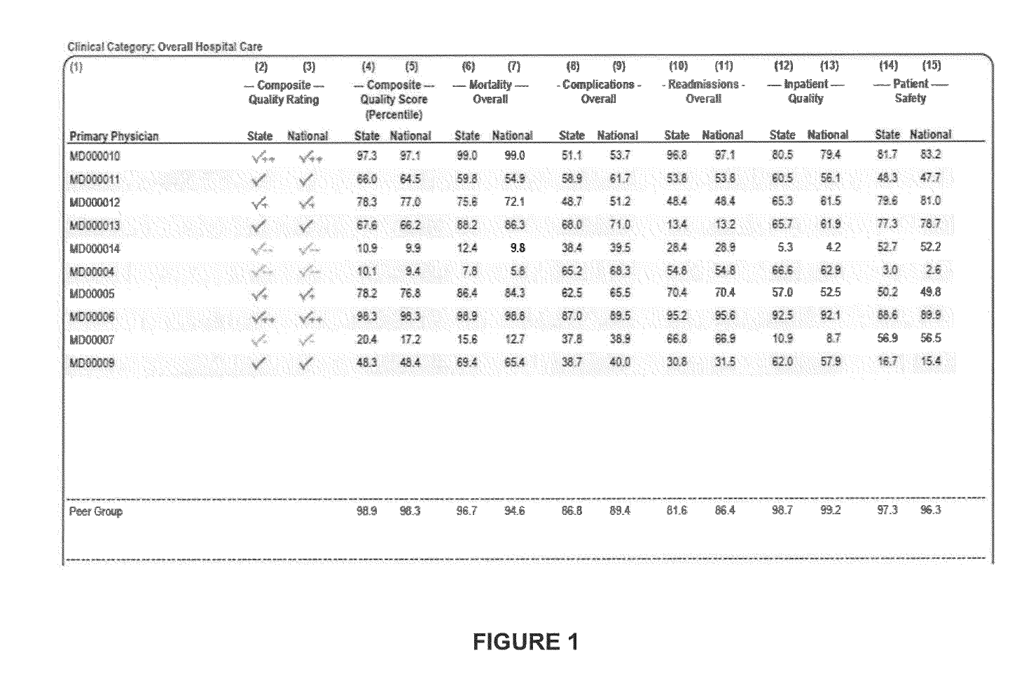

FIG. 1 is an exemplary embodiment of a primarily numerical table template. It represents an exemplary illustration of what would be usable per a presently preferred exemplary embodiment of the presently disclosed subject matter used such as in a web-based software application. As noted, its use results per this example in a composite quality score along with attendant individual quality indicator scores (for example, with reference to mortality, complications, readmissions, inpatient quality, and patient safety).

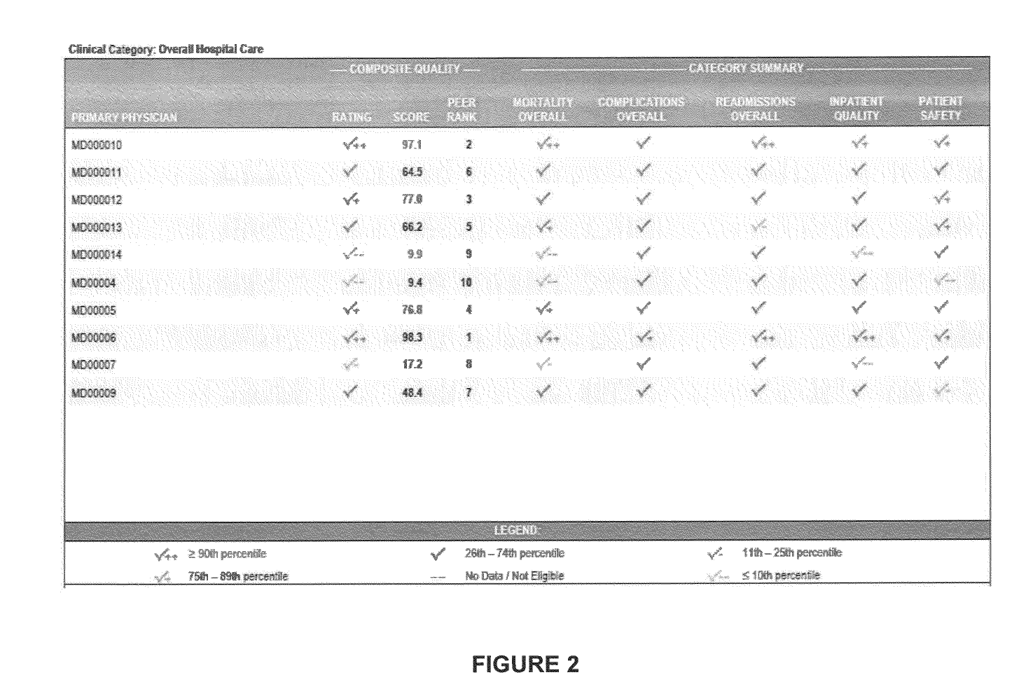

FIG. 2 is an exemplary embodiment of a primarily checkmark-based rating table template, again such as may be practiced in a web-based software application in accordance with a presently preferred exemplary embodiment of the presently disclosed subject matter. It reflects provision of a composite quality rating as well as attendant individual quality indicator ratings (for example, with reference to mortality, complications, readmissions, inpatient quality, and patient safety).

The presently disclosed subject matter is comprised of methodology which may use two distinct, but related, subparts. The first is the construction of a physician's composite quality score. The second is the assignment of a physician's composite quality score to a percentile-based reference range to determine a physician's composite quality rating. Both subparts provide a basis for physician quality assessment and comparison. Per the presently disclosed subject matter, preferably the first subpart makes use of numeric values (for example, percentiles) ranging from 0.01 to 99.9, while the second subpart preferably expresses values as a checkmark icon ranging from a ✓++(“HIGHEST” quality rating) to a ✓−− (“LOWEST” quality rating) for a total of five (5) rating possibilities. Those of ordinary skill in the art will appreciate from the complete disclosure herewith that other nomenclature or other ranges of values may be practiced without departing from the spirit and scope of the presently disclosed subject matter.

The following disclosure enumerates various quality indicators evaluated and the statistical formulas applied per presently disclosed exemplary subject matter to produce a final output which may be displayed, such as via a company's web-based software application or via any of various now or later commercially available spreadsheet templates or databases, or in pdf files, comma delimited flat files, hardcopy reports, and/or via a digital projector.

The following more particularly relates to physician composite quality scoring methodology in accordance with presently disclosed subject matter. In order to provide a valid and reliable comparison of quality performance across physicians, a number of statistical methods may be used prior to calculating an individual percentile score for each quality indicator and a composite quality score across all quality indicators. Based on output derived from five (5) separate binary logistic regression models, the following quality indicators may be calculated:
i. Risk-Adjusted Mortality Index (observed mortality rate÷expected mortality rate)
ii. Risk-Adjusted Complications Index (observed complications rate÷expected complications rate)
iii. Risk-Adjusted Readmissions Index (observed readmissions rate÷expected readmissions rate)
iv. Risk-Adjusted Inpatient Quality Index (observed inpatient quality indicator rate÷expected inpatient quality indicator rate)
V. Risk-Adjusted Patient Safety Index (observed patient safety rate÷expected patient safety rate)
where “1.00”=the national average

The following disclosure enumerates various calculations which may be performed per presently disclosed exemplary subject matter to produce a final output which may be displayed. The terminology “Z-Scores” and “Z-Values” has particular meaning in the context of the presently disclosed subject matter, and both such terminologies as intended herewith are explained hereinbelow.

Specifically, the following calculations may be performed:
1. Calculation of a z-value, using a one-proportion z-test, for each physician for each quality indicator by clinical category to identify the extent to which the physician's performance was statistically significant (i.e., accounts for differences in caseload volume, variation from the mean, and failure rate). Such Z-values may be calculated using a company's state and national inpatient quality indicator databases derived from publically available sources, namely all-payer statewide databases from state government agencies and/or hospital associations or from proprietary sources, namely individual hospital inpatient claims databases, where the formula for calculating the z-value is expressed as:

$$Z \text{-} Value = \frac{( {X}_{o} - {X}_{e} )}{\sqrt{\frac{{X}_{e} ( 1 - {X}_{e} )}{n}}}$$

where “o” equals the observed rate and “e” equals the expected rate.
2. Calculation of a z-score at the state and national level for each z-value in order to standardize scores from different statistical distributions (e.g., mortality vs. complications) so reliable comparisons and calculations could be made (Note: the resulting z-scores correspond to points on a standard normal distribution with a new mean of zero and a new standard deviation of 1; with a theoretical range of −3 and +3 standard deviations). The formula for calculating such z-score is expressed as:

$$Z \text{-} Score = \frac{( x - μ )}{σ}$$

where x=the z-value to be standardized, μ=population mean; σ=standard deviation of the population.
The formula for calculating the population standard deviation in the formula above is expressed as:

$$σ = \sqrt{\frac{{\sum }_{i = 1} {( {X}_{i} - μ )}^{2}}{N}}$$

3. Conversion of both the state and national z-scores for each quality indicator for each physician to percentile scores to identify a physician's relative performance on individual quality indicators within the population of interest. The formula for calculating percentiles is expressed as:

$$Percentile = \frac{Number of Values Below {}_{}^{``}{X}{}_{}^{″}}{Total Number of Values} * 100$$

where x=the identified z-score
4. Averaging of each physician's percentile scores across all relevant quality indicators by clinical category to produce raw composite percentile scores (both state and national). The formula for calculating the average percentile score is expressed as:

Average Percentile=(Mortality Percentile+Complications Percentile+Readmissions Percentile+Inpatient Quality Percentile+Patient Safety Percentile)/5
5. Resealing of all raw composite percentile scores using z-scores to ensure a standard normal distribution and equal weighting using the same formula identified in step 2.
6. Conversion of such resealed composite z-scores back to percentile scores to provide terminal composite quality scores which represent valid, reliable, and user-friendly values for comparing physician performance across all quality indicators for each clinical category.

By incorporating both z-values and z-scores, the presently disclosed methodology produces percentile-based “Composite Quality Scores” which inherently reflect the relative statistical significance of physician performance. Thus, such scores permit a user to accurately and uniformly assess the overall quality of physician care.

There is the potential for confusion regarding the intended differences between z-scores and z-values, in part, because prevailing literature often uses various synonyms for standard scores, such as the following terms: z-scores, z-values, z-statistics, and normal scores. While similar to standard scores as a test of locality, the z-value actually differs due to its ability to determine statistical significance using the z-test.

The following discussion provides provide clarification to one of ordinary skill in the art as to intended differences between a z-score and a z-value as presently used by addressing key differences between such two measures. The context for such discussion relies on quality measures commonly utilized in the field of medical analytics for assessing physician quality performance. The following discussion also provides insight into why a z-score and z-value can at times be mistaken for one another if one assumes the use of individual level data versus aggregate level data.

Essential characteristics of the z-score may be regarded as follows. The typical method for “standardizing” a set of values (finding a common metric or scale) is the calculation of z-scores. Instead of translating data to a fixed range as with percentile resealing, z-scores are anchored by the mean and standard deviation of the original values, and resealed such that the new mean is 0 and the new standard deviation is 1. The resulting z-scores correspond to points on the standard normal curve, with a theoretical range of approximately −3 to +3. Hence, in a standard normal distribution, the standard deviation and z-score are the same value.

Such standardization process is of significance when multiple quality measure statistics such as rates of mortality, complications, and the like are combined into a composite score where each quality measure is drawn from a distinctly different distribution (either normal or non-normal). It should be noted that a standard normal distribution is one of many types of normal distributions and is distinguished by a kurtosis (or peakedness) of 3. Consequently, to accurately combine quality measures from disparate normal distributions, a z-score calculation must first be used to transform each normal distribution into a standard normal distribution.

Z-scores per the presently disclosed subject matter can be calculated for individual level data (e.g., a single patient) or aggregate level data (e.g., a physician with more than one patient). In either case, each value is treated as an “individual” member of a sample. The sample size, then, is equal to the total number of “individuals.” When z-scores are calculated for aggregate data, such as mortality rates for a particular physician, the physician is the “individual” unit of analysis, the group of physicians is the sample, and the sample size is the total number of physicians. The formula for calculating z-scores is as follows:

$$Z \text{-} Score = \frac{X - μ}{σ}$$

Where:
   X=the mean of the distribution of patients for an “individual” physician;
   μ=sample population mean; and
   σ=sample population standard deviation.

Unlike z-values, z-scores should not be interpreted as tests of statistical significance. However, since the z-score is anchored by the mean of the distribution, it can identify values as above or below average (i.e., negative versus positive scores).

The following discussion identifies pertinent characteristics of z-values and clarifies how they differ from z-scores in the present context.

Thus, by comparison to z-scores as used herein, z-values are derived from either the one or two proportion z-test. Z-tests are designed to test hypotheses about summary statistics and therefore, by definition, are only applied to aggregate level data. In the context of data analysis, z-tests are used to increase the interpretability of data by identifying statistical significance using confidence intervals (e.g., CI=95%). Different than z-scores, z-values do not assume that a set of aggregate values are “individual” members of the same sample (e.g., a single patient assessed among a dataset of other patients). Instead, each aggregate value is properly considered a summary of values from a distinct sample with its own distribution (e.g., a group of patients for a particular physician). The sample size, then, varies according to the number of individuals at risk for an adverse event in each sample (e.g., n=25 for Physician A and n=50 for Physician B).

In a sense, a set of z-values is a set of “weighted” z-scores since the z-value assigned to a given physician is “weighted” by the number of patients at risk for the individual physician. The varying reliability of the rates of mortality, complications and the like across different physicians is thus taken into account.

The “z-values” are the result of the separate statistical tests of the difference between each physician's quality measure rate and a standard; they are not points on one curve. The standard used may be the overall or weighted mean of the observed data (e.g., a peer group of physicians), or an external standard such as observed data from a state or the country. The formula for calculating z-values is as follows:

$$Z \text{-} Value = \frac{Observed Rate - Expected Rate}{\sqrt{\frac{Expected Rate * ( 1 - Expected Rate )}{N}}}$$

Where:
   Observed Rate=a physician's actual rate for a specific quality measure (e.g., mortality);
   Expected Rate=the predicted rate based on the sample population (e.g., state);
   N=the number of patients at risk for the physician; and
   Denominator=the defect rate (or failure rate) for the physician.

Unlike resealing with z-scores, z-values do not necessarily correspond to the order in the original data; adjusting for the varying subpopulation sizes may alter the ordering. For z-values, then, the distance between scores is a function of both the distances in the original data and of the varying subpopulation sizes.

Even when population sizes are essentially equal, z-scores and z-values will still at least be slightly different because of the differing assumptions underlying each method and the resulting differences in the calculation methods used. In the present context, z-scores treat aggregate values as though they were values for individuals, while z-values instead treat aggregate values as statistics which summarize distinct samples of values for “groups” of individuals.

The following more particularly relates to physician composite quality rating methodology in accordance with presently disclosed subject matter. First, using the following Table 1, each physician's composite quality rating may be determined by assigning their respective composite quality score (i.e., state or national percentile score) to the appropriate percentile reference range and identifying the associated composite quality rating (✓++ through ✓−−).

TABLE 1
Percentile Reference Range & Attendant Quality Rating

| Distribution | Rating | Percentile Reference Range |
|---|---|---|
| Upper Quartile: | ✓++ | Quality score ≧90^{th} percentile |
| | ✓+ | Quality score between 75th and 89th |
| | | percentiles |
| Middle Quartiles: | ✓ | Quality score between 26th and 74th |
| | | percentiles |
| Lower Quartile: | ✓− | Quality score between 11th and 25th |
| | | percentiles |
| | ✓−− | Quality score ≦10^{th} percentile |

The percentile reference ranges distribute physician Composite Quality Ratings™ as follows:
10% receive the “HIGHEST” quality rating (✓⁺⁺)
15% receive a “HIGH” quality rating (✓⁺)
50% receive an “AVERAGE” quality rating (✓)
15% receive a “LOW” quality rating (✓⁻)
10% receive the “LOWEST” quality rating (✓⁻⁻)

In order to receive a composite quality rating of ✓⁺⁺, a physician must receive a composite quality score ≧90th percentile with no lower than a ✓ rating for any quality indicator; otherwise, a ✓⁺ is assigned. Such requirement prevents physicians with poor quality performance on a particular quality indicator from receiving the highest Composite Quality Rating.

While the specification has been described in detail with respect to specific embodiments of the subject matter, it will be appreciated that those in the art, upon attaining an understanding of the foregoing, may readily conceive of alterations to, variations of, and equivalents to these embodiments. Accordingly, the scope of the present subject matter should be assessed as that of the appended claims and any equivalents thereto.

### APPENDIX A

### Part of the Subject Specification

Identification of Exemplary Clinical Categories

1. Overall Hospital Care

2. Overall Medical Care

3. Overall Surgical Care

4. Cancer Care

5. Cardiac Care

6. Cardiac Surgery (Major)

7. Coronary Artery Bypass

8. Gall Bladder Removal

9. Gastrointestinal Care

10. Gastrointestinal Hemorrhage

11. General Surgery

12. Heart Attack Treatment

13. Heart Failure Treatment

14. Hip Fracture Repair

15. Interventional Carotid Care

16. Interventional Coronary Care

17. Joint Replacement

18. Major Bowel Procedures

19. Maternity Care

20. Neurological Care

21. Neurological Surgery (Major)

22. Organ Transplants

23. Orthopedic Care

24. Orthopedic Surgery (Major)

25. Pneumonia Care

26. Pulmonary Care

27. Spinal Fusion

28. Spinal Surgery

29. Stroke Care

30. Transplant of Bone Marrow

31. Transplant of Heart

32. Transplant of Kidney

33. Transplant of Liver

34. Transplant of Lung

35. Trauma Care

36. Vascular Surgery

37. Women's Health

What is claimed is:

1. A percentile-based scoring method for evaluating and comparing composite quality performance of physicians for the purpose of identifying opportunities for clinical quality improvement and selecting or deselecting physicians for value-based managed care contracting, comprising the steps of:
calculating respective z-values for a plurality of physicians for each of a plurality of quality measurement indices by clinical category;
calculating respective standardized z-scores for each z-value;
converting said z-scores for each quality indicator for each physician to percentile scores to identify relative physician performance on individual quality indicators within a population of interest;
averaging each physician's percentile scores across all relevant quality indicators by clinical category to produce raw composite percentile scores;
resealing all raw composite percentile scores using z-scores to obtain standard normal distribution and equal weighting; and
converting the resealed composite z-scores back to percentile scores to provide a terminal composite quality score for each physician.

2. A method as in claim 1, wherein:
said calculating z-values step comprises calculating z-values for a plurality of physicians for each of the plurality of quality measurement indices by clinical category using respectively available both state and national inpatient quality indicator databases;
said calculating z-score step comprises calculating z-scores at both state and national levels respectively for each z-value in order to obtain standardized scores.

3. A method as in claim 2, wherein:
said converting said z-scores step comprises converting both state and national z-scores for each quality indicator for each physician to percentile scores to identify relative physician performance on individual quality indicators within the population of interest; and
said averaging step comprises averaging each physician's percentile scores across all relevant quality indicators by clinical category to produce raw composite percentile scores at both state and national levels.

4. A method as in claim 1, further comprising using a relative rating for evaluating and comparing composite quality performance of physicians for the purpose of identifying opportunities for clinical quality improvement and selecting or deselecting physicians for value-based managed care contracting, said relative rating comprising assigning each physician's composite quality score to one of a selected number of percentile reference ranges and identifying the associated composite quality rating from a highest category to a lowest category.

5. A method as in claim 4, wherein said categories are delineated such that a composite quality score greater than or equal to the 90^{th} percentile equals the “HIGHEST” composite quality rating, between the 75^{th} and 89^{th} percentiles equals a “HIGH” composite quality rating, between the 26^{th} and 74^{th} percentiles equals an “AVERAGE,” composite quality rating, between the 11^{th} and 25^{th} percentiles equals a “LOW” composite quality rating, and less than or equal to the 10^{th} percentile equals the “LOWEST” composite quality rating.

6. A method as in claim 5, wherein said relative rating further includes demoting physicians with the “Highest” composite quality rating to a “HIGH” composite quality rating if any quality indicator is lower than an “AVERAGE” quality rating.

7. A method as in claim 4, further including calculating a quality score and rating for quality measures comprising at least one of risk-adjusted mortality index, risk-adjusted complications index, risk-adjusted readmissions index, risk-adjusted inpatient quality index, and risk-adjusted patient safety index.

8. A non-transient computer readable medium containing program instructions for causing a computer to perform the method of:
calculating respective z-values for a plurality of physicians for each of a plurality of quality measurement indices by clinical category;
calculating respective standardized z-scores for each z-value;
converting said z-scores for each quality indicator for each physician to percentile scores to identify relative physician performance on individual quality indicators within a population of interest;
averaging each physician's percentile scores across all relevant quality indicators by clinical category to produce raw composite percentile scores;
resealing all raw composite percentile scores using z-scores to obtain standard normal distribution and equal weighting; and
converting the resealed composite z-scores back to percentile scores to provide a terminal composite quality score for each physician.
